(19) United States
(12) Patent Application Publication
(10) Pub. No.: US 2026/0102897 A1
(43) Pub. Date: Apr. 16, 2026

(54) BIT BAR

(71) Applicant: TECHTRONIC CORDLESS GP, Anderson, SC (US)

(72) Inventors: Drew A. Dahill, Greenville, SC (US); Ashley Chapman Antley, Greenville, SC (US); Ryan A. Hirtz, Pelzer, SC (US)

(21) Appl. No.: 19/356,499

(22) Filed: Oct. 13, 2025

Related U.S. Application Data
(60) Provisional application No. 63/707,100, filed on Oct. 14, 2024.

(51) Int. Cl. B25H 3/00

(52) U.S. Cl. CPC B25H 3/003

(57) ABSTRACT

A bit holder including a bit bar defining receptacles each configured to support a bit, each of the receptacles defined by a first receptacle wall, a second receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a first projection extending from the first bridge segment and a second projection extending from the second bridge segment, wherein the first projection is flexible relative to the first bridge segment and the second projection is flexible relative to the second bridge segment such that the first projection, the second projection to at least partially cooperatively hold the bit in place.

### CROSS-REFERENCE TO RELATED APPLICATION

This application claims priority to U.S. Provisional Patent Application No. 63/707,100, filed on Oct. 14, 2024, the entire contents of which are incorporated herein by reference.

### BACKGROUND

The present disclosure relates to a bit bar or bit holder for supporting a plurality of tool bits, and more particularly to a bit bar or bit holder that receives and locks one or more bits in place.

### SUMMARY

In some aspects, the invention provides a bit holder including: a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a first projection extending from the first bridge segment and a second projection extending from the second bridge segment, wherein the first projection is flexible relative to the first bridge segment and the second projection is flexible relative to the second bridge segment such that the first projection, the second projection to at least partially cooperatively hold the bit in place.

In some aspects, the invention provides a bit holder including a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a projection extending from the first bridge segment, wherein the projection is flexible relative to the first bridge segment to partially guide the bit into a first pocket defining an insertion position of the bit on insertion into a corresponding receptacle, wherein the projection is further flexible relative to the first bridge element on movement of the bit from the first pocket to a second pocket defining a locked position of the bit, and wherein projection is engageable with the bit in the insertion position and in the locked position of the bit.

In some aspects, the invention provides a bit holder including: a bit bar defining receptacles each configured to support a bit, each of the receptacles defined by a first receptacle wall and a second receptacle wall opposite the first receptacle wall, the bit bar further including a first projection extending inward into the receptacle, and a second projection extending inward into the receptacle opposite the first projection, wherein each of the first projection and the second projection is flexible relative to each other, and wherein each of the first projection and the second projection includes a first surface cooperating with the first receptacle wall to define a first space, a second surface oriented at a non-zero angle relative to the first surface and cooperating with the second receptacle wall to define a second space at least partially offset from the first space, and a ridge defining an edge disposed between the first surface and the second surface.

Other aspects of the disclosure will become apparent by consideration of the detailed description, the claims, and accompanying drawings. The drawings illustrate exemplary embodiments of the technology and, together with the description, serve to explain the principles of the technology.

### BRIEF DESCRIPTION OF THE DRAWINGS

FIG. 1 is a perspective view illustrating a bit bar including receptacles for holding accessory tool hex bits.

FIG. 2 is another perspective view of the bit bar of FIG. 1.

FIG. 3A is a perspective view of the bit bar including exemplary bits coupled to the bit bar in an inserted position within corresponding receptacles.

FIG. 3B is a perspective view of the bit bar including exemplary bits coupled to the bit bar in a locked position within corresponding receptacles.

FIG. 4 is a first section view of the bit bar taken along line 4-4 in FIG. 1 and illustrating first portions of receptacles for receiving hex bits.

FIG. 5 is another section view of the bit bar taken along line 5-5 in FIG. 1 and illustrating second portions of the receptacles.

FIGS. 6A to 6C are other section views of the bit bar taken along line 6-6 in FIG. 1 illustrating a first side of some receptacles.

FIGS. 7A to 7C are a second side section views of the bit bar taken along line 7-7 in FIG. 1 illustrating a second side of some receptacles.

FIGS. 8A to 8C are views of the bit bar taken from a top or bit insertion side and illustrating one receptacle.

FIG. 9 is a perspective view of the receptacle of FIG. 8.

FIG. 10 is another perspective view of the receptacle of FIG. 8 taken from the opposite side relative to FIG. 9.

FIG. 11 is a top view of the receptacle of FIG. 8 illustrating a first space for receiving a hex bit and a hex bit base oriented in the first space.

FIG. 12 is a top view of the receptacle of FIG. 8 illustrating a second space for receiving a hex bit and a hex bit base oriented in the second space.

FIG. 13 is a perspective view of a bit bar according to a further embodiment having two rows of receptacles.

FIG. 14 is a perspective view of a bit bar according to a further embodiment having four rows of receptacles.

FIG. 15 is a perspective view of a bit bar according to a further embodiment.

FIG. 16A is a bottom view of the bit bar of FIG. 15.

FIG. 16B is a top view of the bit bar of FIG. 15.

FIG. 17 is a cross-sectional side view of the bit bar of FIG. 15 illustrating an exemplary bit coupled to the bit bar in locked and unlocked positions.

### DETAILED DESCRIPTION

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways.

Also, it is to be understood that the phraseology and terminology used herein is for the purpose of description and should not be regarded as limiting.

Any implementation described herein as “exemplary” is not necessarily to be construed as preferred or advantageous over other implementations. It will be apparent to those skilled in the art that modifications and variations can be made in the present technology without departing from the scope or spirit of the claimed technology.

The singular forms “a,” “an,” and “the” include plural references unless the context clearly dictates otherwise. The terms “coupled,” “fixed,” “attached to,” and the like refer to both direct coupling, fixing, or attaching, as well as indirect coupling, fixing, or attaching through one or more intermediate components or features, unless otherwise specified herein. As used herein, the terms “comprises,” “comprising,” “includes,” “including,” “has,” “having” or any other variation thereof, are intended to cover a non-exclusive inclusion. For example, a process, method, article, or apparatus that comprises a list of features is not necessarily limited only to those features but may include other features not expressly listed or inherent to such process, method, article, or apparatus. Further, unless expressly stated to the contrary, “or” refers to an inclusive- or and not to an exclusive- or. For example, a condition A or B is satisfied by any one of the following: A is true (or present) and B is false (or not present), A is false (or not present) and B is true (or present), and both A and B are true (or present).

Terms of approximation, such as “about,” “generally,” “approximately,” or “substantially,” include values within ten percent greater or less than the stated value. When used in the context of an angle or direction, such terms include within ten degrees greater or less than the stated angle or direction. For example, “generally vertical” includes directions within ten degrees of vertical in any direction, (e.g., clockwise, or counterclockwise).

Benefits, other advantages, and solutions to problems are described below with regard to specific embodiments. However, the benefits, advantages, solutions to problems, and any feature(s) that may cause any benefit, advantage, or solution to occur or become more pronounced are not to be construed as a critical, required, or essential feature of any or all the claims.

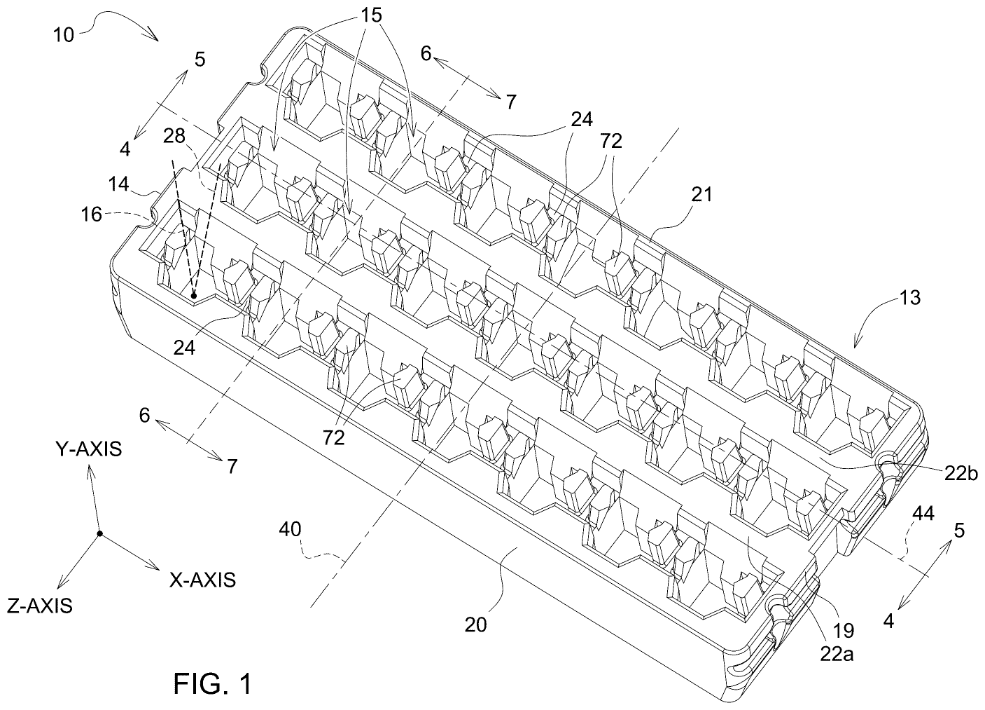

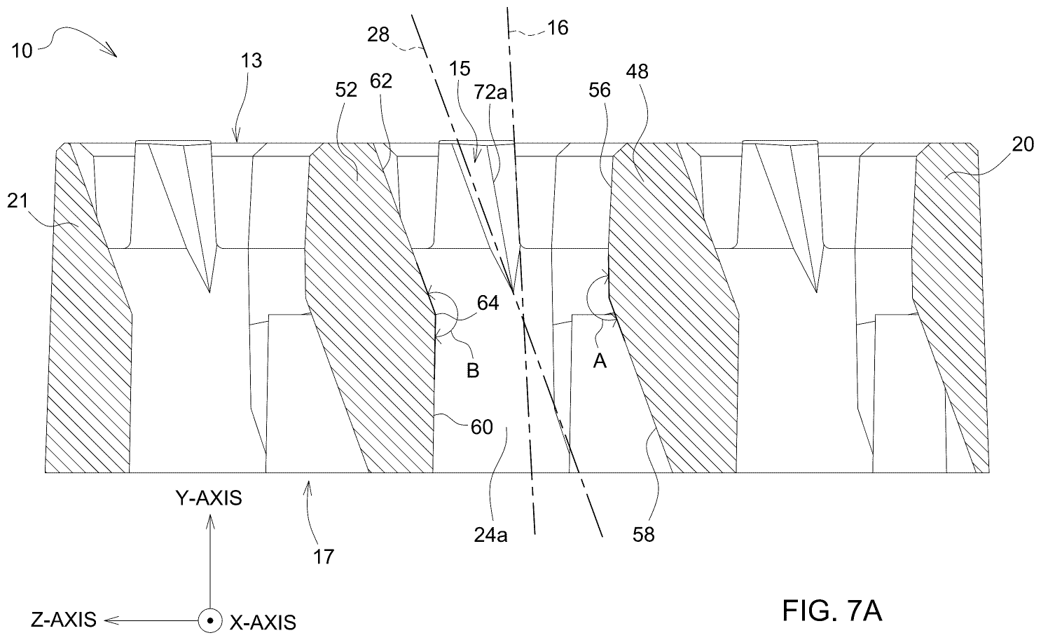

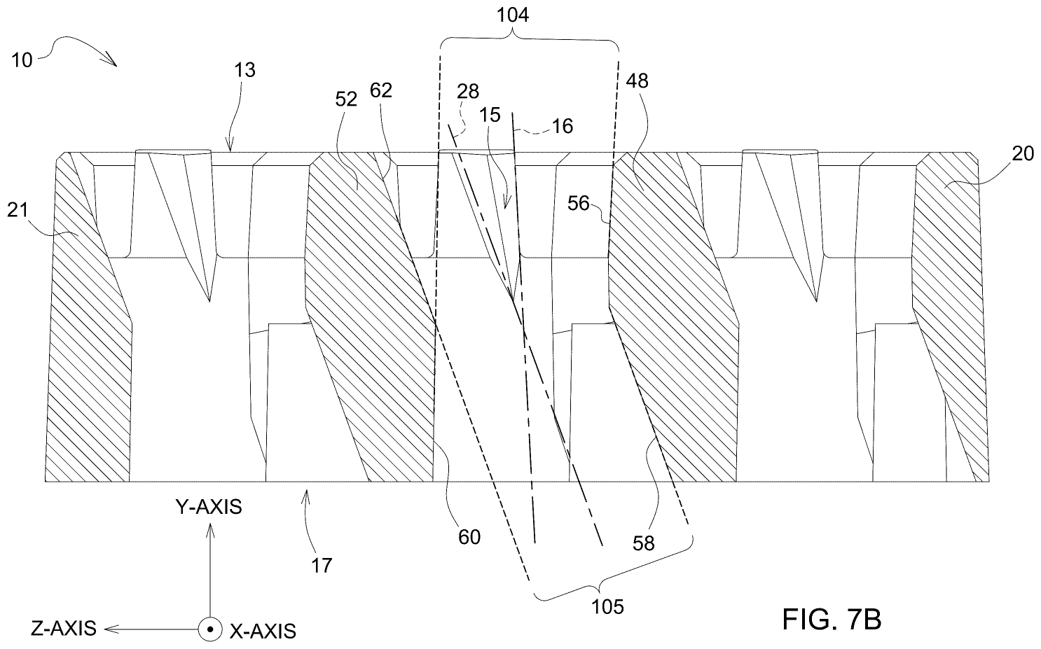

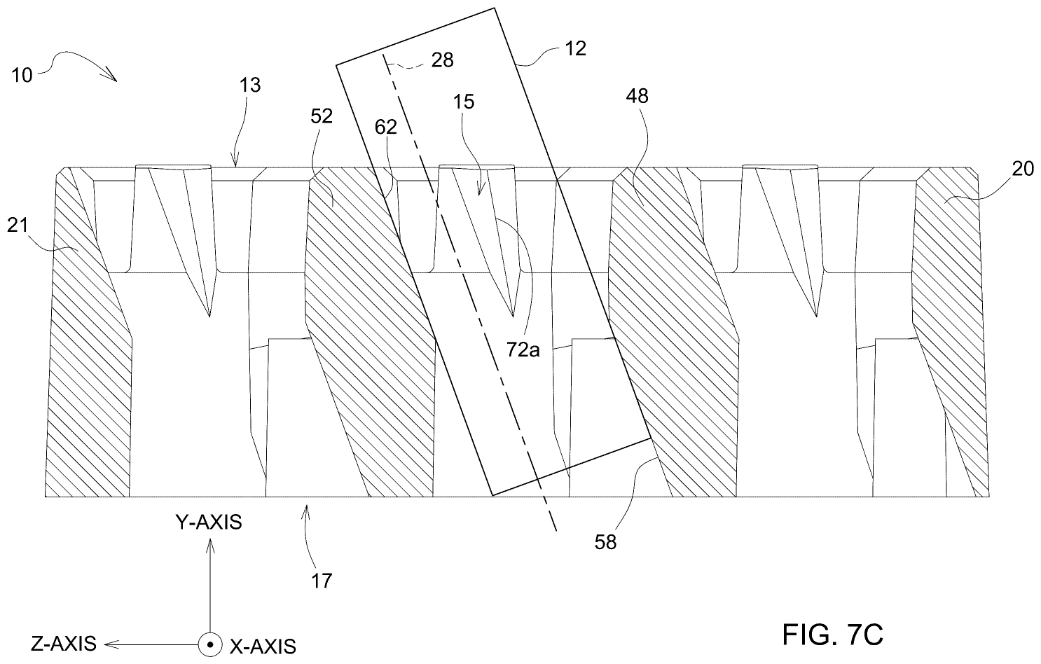

FIGS. 1, 2, 3A, and 3B illustrate an exemplary bit holder formed as a bit bar 10 with receptacles 15 that can be used to hold, store, and/or organize a plurality of bits 12 that have a shaped base 11 (e.g., a hex-shaped base for use with hex tools). The bit bar 10 includes a first or upper side 13 that is structured to receive one or more bits 12 (i.e. the first side 13 is a bit receiver side) and a second or lower side 17 (e.g., a base side) that is opposite the first side 13. The illustrated bit bar 10 may be molded as a monolithic structure or manufactured in other ways. As best shown in FIGS. 1, 6, and 7, the bit bar 10 is described herein relative a coordinate system such that the bit bar 10 has a length defined along an X-axis, has a width defined along a Z-axis, and has a height defined along a Y-axis. As described below, the bit bar 10 has structure that extends along or is oriented relative to the coordinate system. It will be appreciated that, as viewed in the Figures, the X-axis defines a lateral direction associated with the bit bar 10 (e.g., defining a left side of the bit bar 10 and a right side of the bit bar 10, respectively, when viewed from a front of the bit bar 10), the Y-axis defines an upward direction and a downward direction associated with the bit bar 10 (e.g., defining a top or upper side of the bit bar 10 and a bottom or lower side of the bit bar 10, respectively, when viewed from the front of the bit bar 10), and the Z-axis defines a forward direction and a rearward direction (e.g., defining a front side of the bit bar 10 and a rear side of the bit bar 10, respectively).

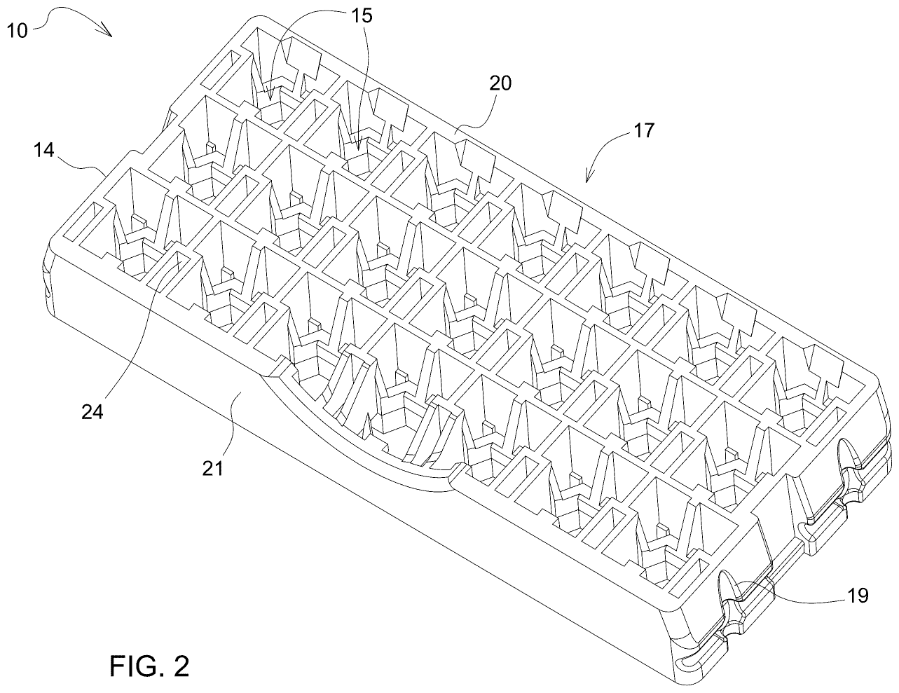

With reference to FIGS. 1 and 2, the bit bar 10 includes a first side wall segment 14, a second side wall segment 19 opposite the first side wall segment 14, a first or front perimeter wall segment 20, and a second or rear perimeter wall segment 21 that is opposite the first perimeter wall segment 20. The first side wall segment 14 is elongated along a first axis 40 (defining a plane extending along the Z-axis parallel to the Y-axis). Accordingly, the second side wall segment 19 is similarly elongated along the first axis 40. The first perimeter wall segment 20 is elongated along a second axis 44(defining a plane extending along the X-axis parallel to the Y-axis). The second perimeter wall segment 21 is elongated along the second axis 44. The first and second side walls 14, 19 extend between and interconnect the first perimeter wall segment 20 and the second perimeter wall segment 21, and the first and second side walls 14, 19 extend across (e.g., perpendicular to) the second axis 44 and parallel to the first axis 40. As shown, the first perimeter wall segment 20, the second perimeter wall segment 21, the first side wall segment 14, and the second side wall segment 19 define the outer bounds of the bit bar 10 and form a perimeter that is substantially rectangularly-shaped. It will be appreciated that the bit bar 10 may have other shapes.

With reference to FIGS. 1-5, the bit bar 10 includes one or more divider walls 22 (e.g., the bit bar 10 is illustrated with two divider walls 22a, 22b) that extend between the first side wall 14 and the second side wall 19 parallel to the first perimeter wall segment 20 and the second perimeter wall segment 21. It should be appreciated that the bit bar 10 may include any quantity of divider walls 22.

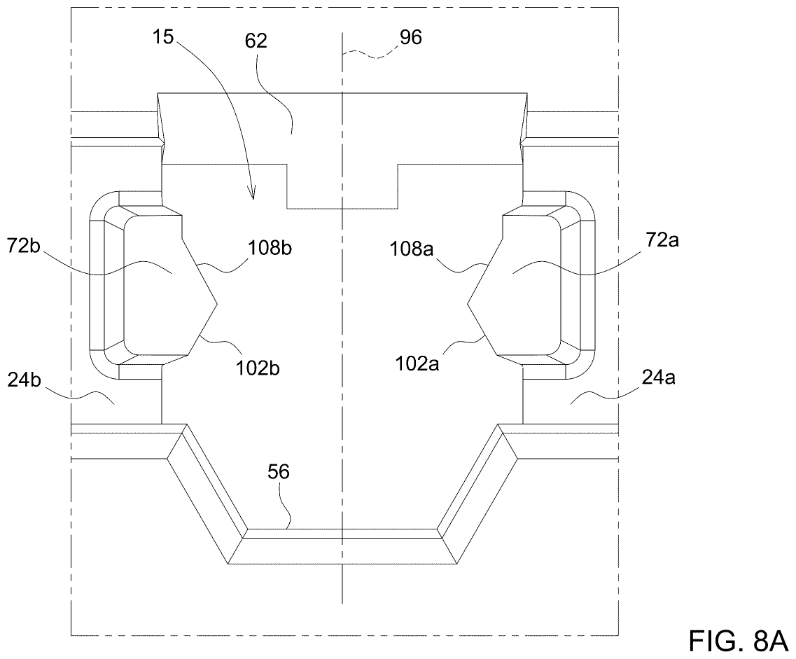

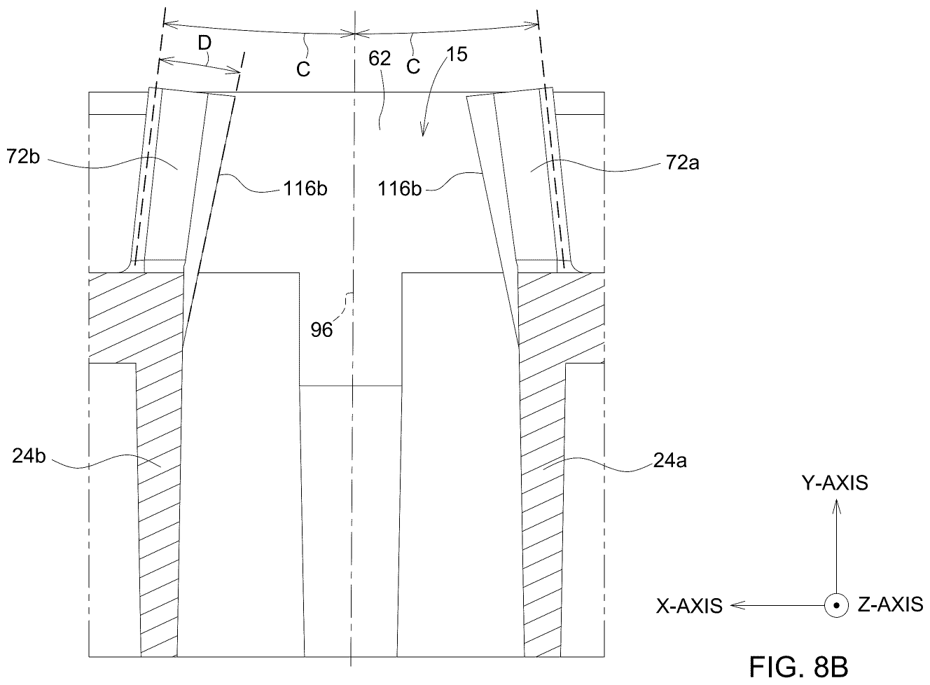

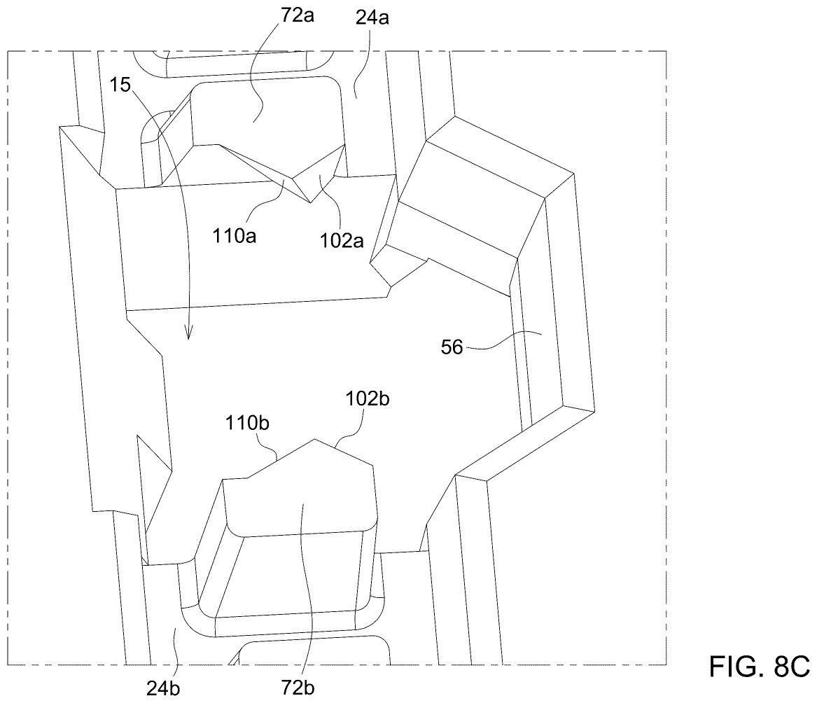

As best shown in FIGS. 1, 2, and 5-10, the bit bar 10 includes bridge segments 24 that extend between and interconnect one of the first and second perimeter wall segments 20, 21 and an adjacent divider wall 22, and bridge segments 24 that extend between and interconnect adjacent divider walls 22. The first side wall segment 14 and the second side wall segment 19 each define a portion of the bridge segments 24.

The receptacles 15 are defined by different combinations of the walls of the bit bar 10. For example, and as best shown in FIG. 1, some of the receptacles 15 in a first row of the bit bar 10 adjacent the front are defined by the first perimeter wall segment 20, one of the side walls 14, 19, a divider wall 22 (e.g., the divider wall 22a), and a bridge segment 24 that is adjacent the corresponding side wall 14, 19. Other receptacles 15 in the first row are defined by the first perimeter wall segment 20, the adjacent divider wall 22 (e.g., the first divider wall 22a), and two adjacent bridge segments 24. With continued reference to FIG. 1, additional receptacles 15 (e.g., the receptacles in a second row of the bit bar 10) are defined by adjacent divider walls 22 and either the side wall 14 or the side wall 19 in combination with an adjacent bridge segment 24. Still other receptacles in the illustrated example (e.g., the receptacles 15 in the third or rear row of the illustrated bit bar 10) are defined by the second perimeter wall segment 21, one of the side walls 14, 19, a divider wall 22 (e.g., the divider wall 22b), and a bridge segment 24 that is adjacent the corresponding side wall 14, 19. Additional receptacles 15 in the third row of the illustrated bit bar are defined by the second perimeter wall segment 21, the adjacent divider wall 22 (e.g., the first divider wall 22b), and two adjacent bridge segments 24. The illustrated bit bar 10 includes twenty-one receptacles 15 that can receive a corresponding quantity of bits 12. It will be appreciated that the bit bar 10 may include any quantity of receptacles 15.

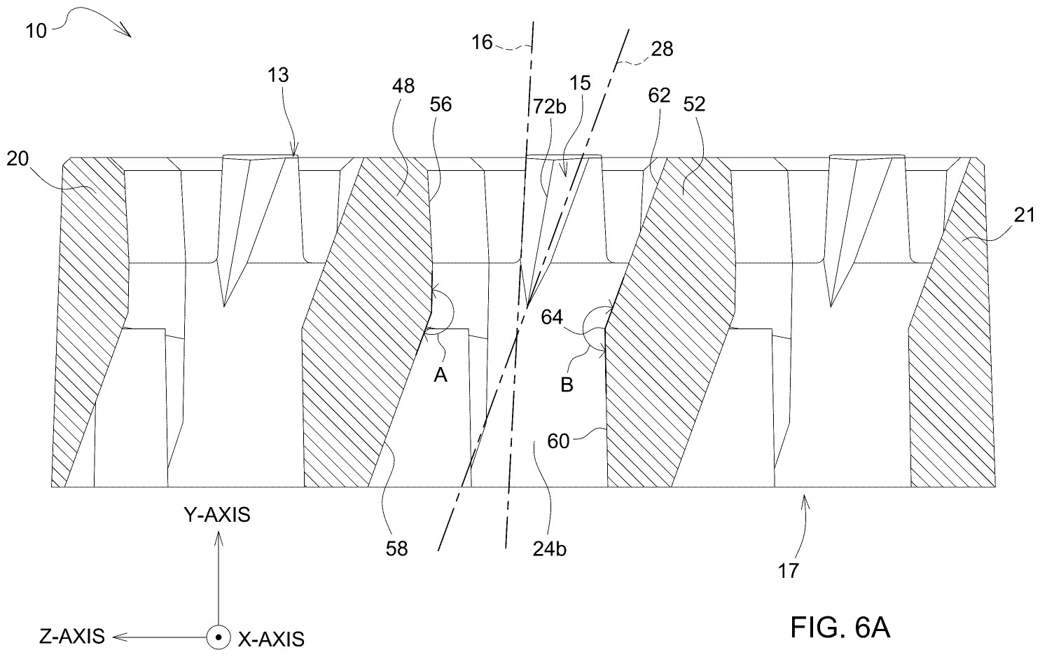

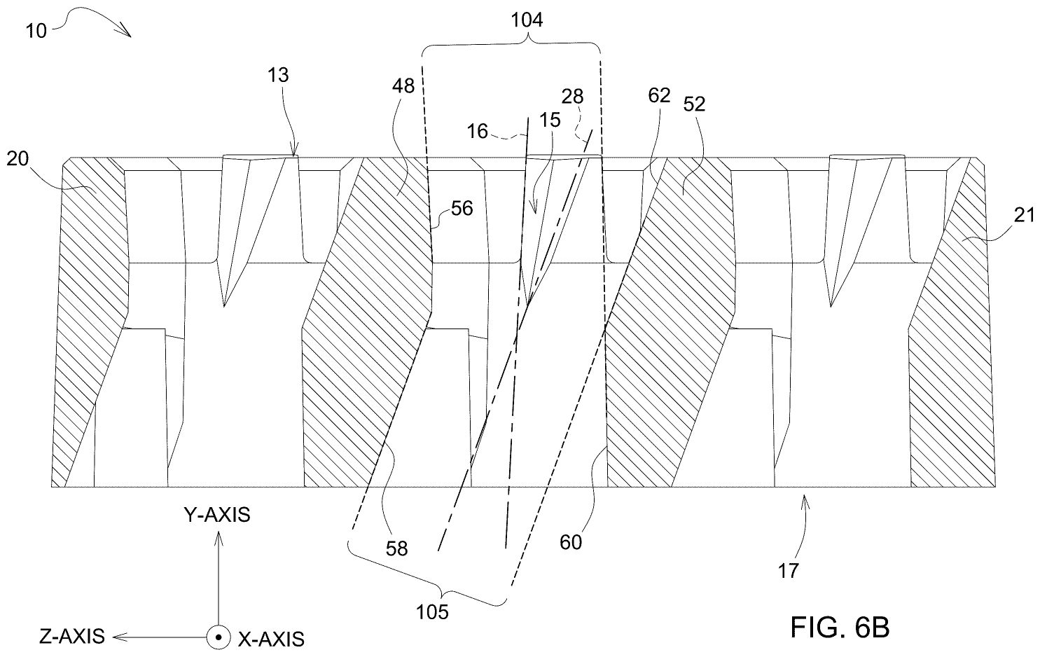

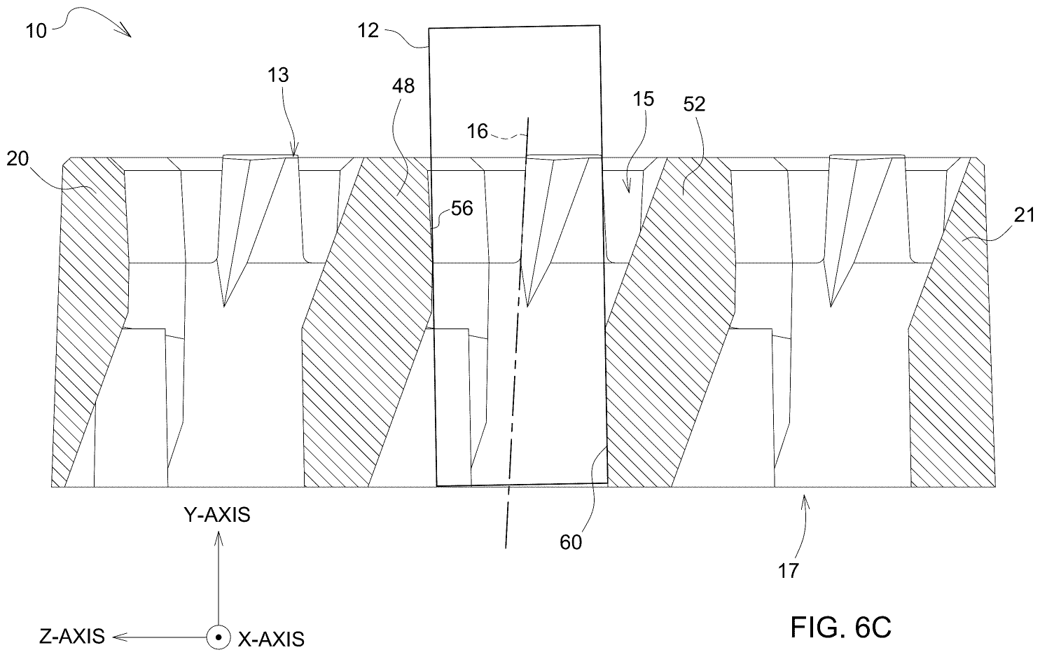

Each receptacle 15 is shaped to receive a corresponding bit 12 and facilitates insertion of the bit 12 into the bit bar 10 and movement of the bit 12 to a locked position that firmly holds the bit 12 in place. With reference to FIGS. 1 and 6, each receptacle 15 has a bit receiver axis 16 along which the bit 12 can be inserted (e.g., received) or removed relative to the bit bar 10, and a bit lock axis 28 corresponding to the locked position of the bit 12 in the receptacle 15. It will be appreciated that, consistent with the description below, the bit bar 10 saves space relative to existing bit bars and defines a bit bar lock and release mechanism such that each bit 12 can be inserted, locked, unlocked, and removed with relative ease.

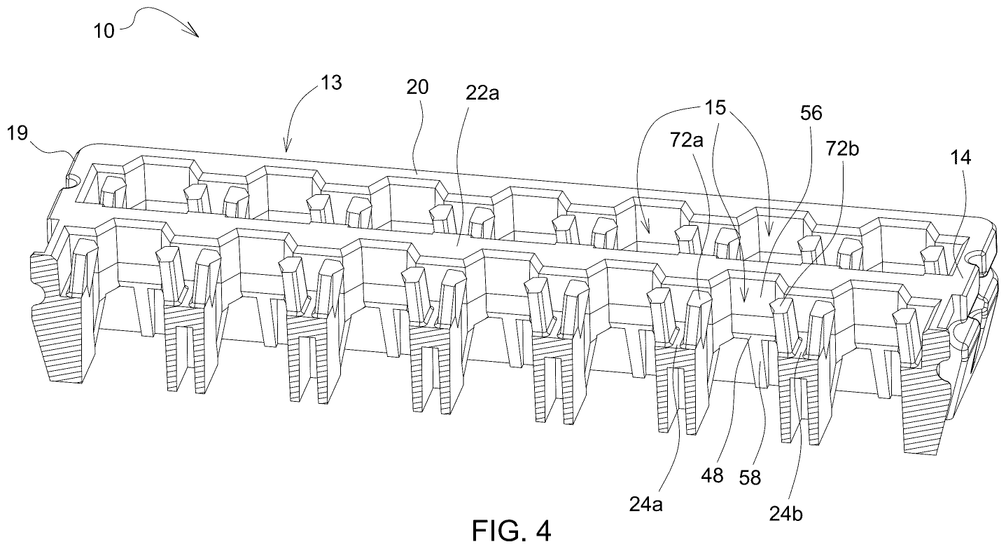

FIGS. 4-10 illustrate structure associated with each receptacle 15 in greater detail. While the specific segments that define each receptacle 15 may differ, as described above, it will be appreciated that the description below relative to an exemplary receptacle 15 applies to all receptacles 15.

Each of the exemplary receptacles 15 is defined by a first receptacle wall 48 (e.g., a second, or receptacle-facing side of the first divider wall 22a), a second receptacle wall 52 (e.g., an internal or receptacle-facing side of the second divider wall 22b), a first bridge segment 24a, and a second bridge segment 24b. The first bridge segment 24a extends between and interconnects the first receptacle wall 48 and the second receptacle wall 52 on a first side of the receptacle 15. The second bridge segment 24b extends between and interconnects the first receptacle wall 48 and the second receptacle wall 52 on a second side of the receptacle 15 opposite the first side. The portions of the first receptacle wall 48 that define the receptacle 15 include a substantially vertical upper surface 56 extending from the upper side 13 to an inflection point and an angled lower surface 58 extending from the inflection point to the lower side 17. The portions of the second receptacle wall 52 that define the receptacle 15 include an angled (relative to vertical) upper surface 62 extending parallel to the angled lower surface 58 from the upper side 13 to an inflection point and a vertical lower surface 60 extending parallel to the vertical upper surface 56 extending from the inflection point to the lower side 17. The angles A, B between the vertical surfaces 56, 60 and the angled surfaces 58, 62 are the same, and in some embodiments are approximately 200 degrees (e.g., 200 degrees, 190-210 degrees, 195-205 degrees). Written another way, the angles A, B are offset from vertical by approximately 20 degrees.

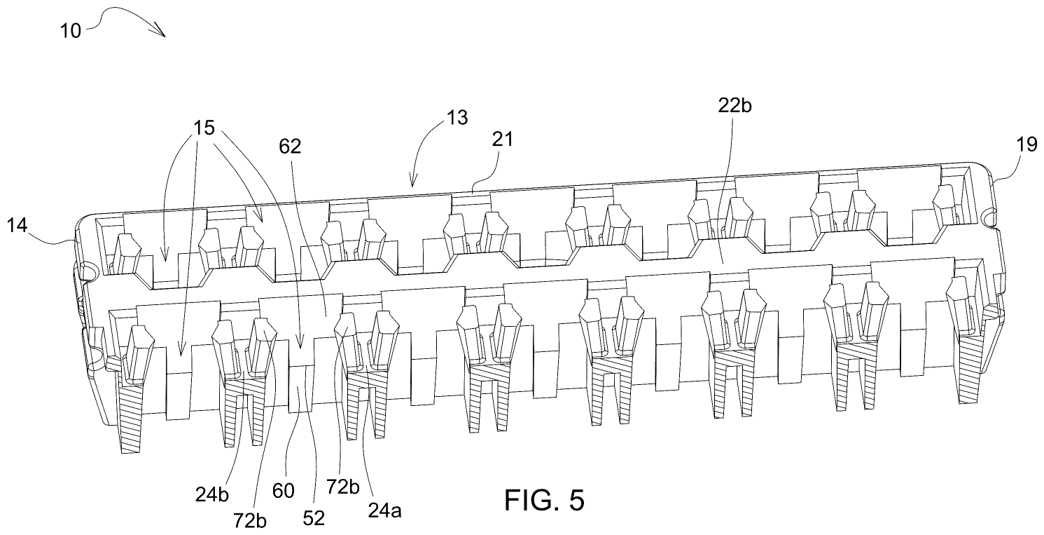

As best illustrated in FIGS. 4 and 5, the first receptacle wall 48 is defined by a hex-shaped profile that partially matches the shape of the base of the bit 12. The first receptacle wall 48 includes a hex-shaped engagement portion 80 configured to engage a bottom of the bit 12 in the locked position. The second receptacle wall 52 is defined by a first or lower planar surface 88 and a second or upper planar surface 92. The lower planar surface 88 is defined by a portion of the second receptacle wall 52 that is bounded by the second side 17 of the bit bar 10 and intermediate point 53 of the second receptacle wall 52. In contrast, the upper planar surface 92 is defined by a portion of the second receptacle wall 52 that is bounded by the first side 13 of the bit bar 10 and the intermediate point 53 of the second receptacle wall 52. The lower planar surface 88 is parallel to the received bit axis 26 extending along the first receptacle wall 48 and through a center of the hex-shaped profile. The upper planar surface 92 is oriented at a non-zero angle relative to the lower planar surface 88 and relative to the bit receiver axis 16. In the present embodiment, the non-zero angle is approximately 20 degrees. However, it should be understood that the non-zero angle may be any non-zero angle between 0 degrees and 90 degrees. The upper planar surface 92 may also be understood as an upper portion of the second receptacle wall 52 configured to engage the bit 12 in the locked position.

As best illustrated in FIGS. 6-8, the first bridge segment 24a and the second bridge segment 24b are oriented symmetrically about a plane 96 extending perpendicular through the first receptacle wall 48 and the second receptacle wall 52. Accordingly, the first bridge segment 24a and the second bridge segment 24b are mirror images of one another about the plane 96.

A first projection 72 extends from the first bridge segment 24a. The first projection 72 is configured to engage the bit 12 when the bit is in the receptacle 15. The first projection 72 extends toward the receptacle along the X-axis. The first projection 7 extends upward from a top of the first bridge segment 24a and inward relative to the first bridge segment 24a into the receptacle 15. Similarly, a second projection 76 extends from the second bridge segment 24b. The second projection 76 is configured to engage the bit 12 when the bit 12 is in the receptacle 15. The second projection 76 extends toward the receptacle 15 along the X-axis. The second projection 76 extends upward from a top of the second bridge segment 24b and inward relative to the first bridge segment 24a into the receptacle 15. Similar to the first bridge segment 24a and the second bridge segment 24b, the first projection 72 and the second projection 76 are mirror images of one another about the plane 96.

The first projection 72 and the second projection 76 are flexible relative to and independent of each other. The first projection 72 is flexible relative to the first bridge segment 24a to partially guide the bit 12 into the first space 104. Similarly, the second projection 76 is flexible relative to the second bridge segment 24b to partially guide the bit 12 into the first space 104. Accordingly, the first projection 72 defines an insertion position of the bit 12. Additionally, the first projection 72 is flexible relative to the first bridge segment 24a on movement of the bit 12 from the first space 104 to the second space 105 defining the locked position of the bit 12. Similarly, the second projection 76 is flexible relative the second bridge segment 24b on movement of the bit 12 from the first space 104 to the second space 105. Accordingly, the first projection 72 and the second projection 76 are both engageable with the bit 12 in both the insertion position and in the locked position of the bit 12.

The first projection 72 and the second projection 76 are disposed at opposite non-zero angles to the Y-axis. Stated another way, the first projection 72 may be disposed at an angle of 15 degrees with respect to the Y-axis. In contrast, the second projection 76 may be disposed at an angle of −15 degrees with respect to the Y-axis. Accordingly, the first projection 72 and the second projection 76 are each disposed angularly inward toward the plane 96.

The first projection 72 is flexible relative to the first bridge segment 24a and the second projection 76 is flexible relative to the second bridge segment 24b such that the first projection 72 and the second projection 76 are configured to cooperate to hold the bit 12 in the locked position. When the bit 12 is in the locked position, the engagement portion 80 of the first receptacle wall 48 is configured to engage a first side of the bit 12 and the upper planar surface 92 of the second receptacle wall 52 is configured to engage a second side of the bit 12. Therefore, the engagement portion 80 of the first receptacle wall 48 is configured to engage a first side of the bit 12 and the upper planar surface 92 of the second receptacle wall 52 are configured to cooperatively hold the bit 12 in place. Accordingly, each of the engagement portion 80, the upper planar surface 92, the first projection 72, and the second projection 76 are configured to cooperatively hold the bit in place.

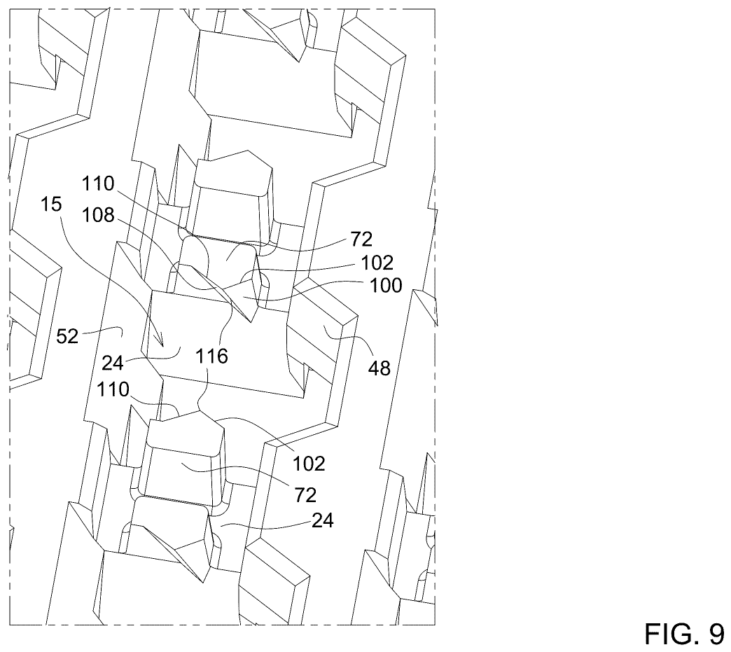

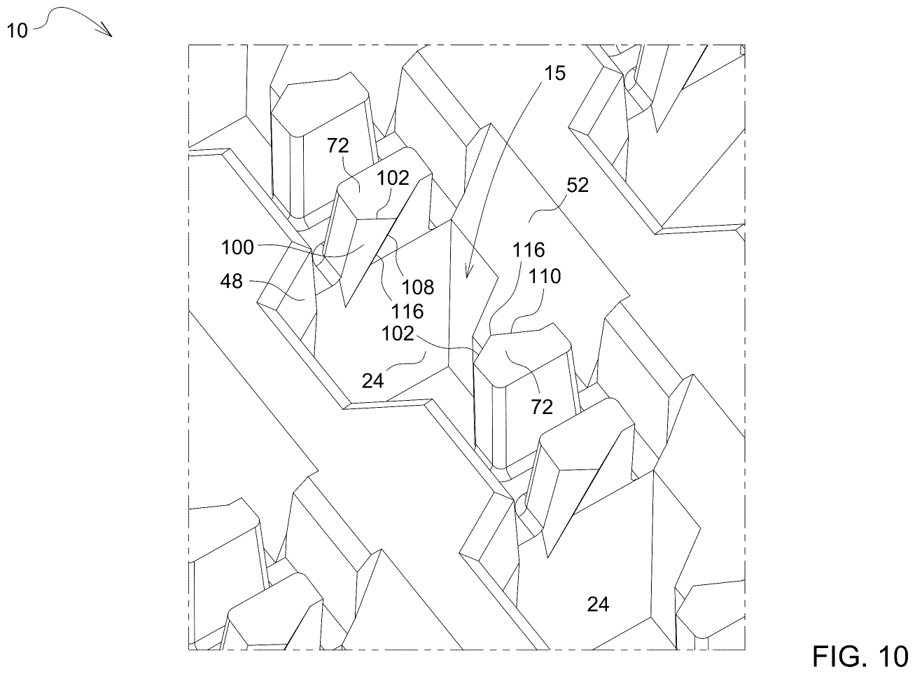

As illustrated in FIGS. 9 and 10, the first projection 72 and the second projection 76 are mirror images of one another about the plane 96. Accordingly, the first projection 72 includes a first surface 100, a second surface 108 oriented at a non-zero angle relative to the first surface 100, a first upper edge 97 defining a top of the first projection 72, and a first ridge 116 defining an edge defined between the first surface 100 and the second surface 108. The first surface 100 and the second surface 108 are angled relative to one another along the first ridge 116.

Similarly, the second projection 76 includes a third surface 120, a fourth surface 124 oriented at a non-zero angle relative to the third surface 120, a second upper edge 126 defining a top of the second projection 76, and a second ridge 128 defining an edge defined between the third surface 120 and the fourth surface 124. The third surface 120 and the fourth surface 124 are angled relative to one another along the second ridge 128. The third surface 120 cooperates with the second receptacle wall 52 to define the first space 104. The fourth surface 124 cooperates with the first receptacle wall 48 to define the second space 105 at least partially offset from the first space 104. The second space 105 at least partially overlaps the first space 104 at a top of the bit bar 10. In other words, the third surface 120 is engageable with the bit 12 in the insertion position and the fourth surface 124 is engageable with the bit 12 in the locked position.

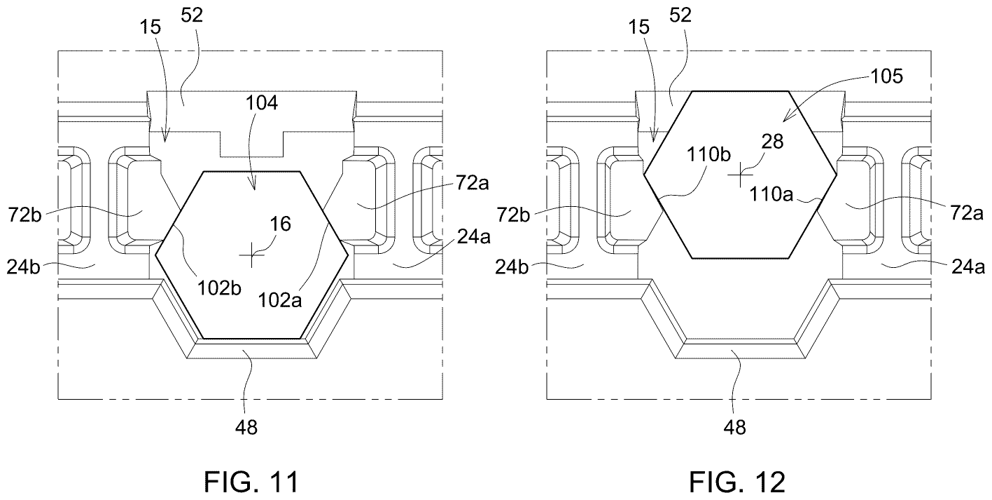

As illustrated in FIGS. 10-12, the first surface 100 and the third surface 120 cooperate with the second receptacle wall 52 to define a first space 104. The second surface 108 and the fourth surface 124 cooperate with the first receptacle wall 48 to define a second space 105 at least partially offset from the first space 104. The second space 105 at least partially overlaps the first space 104 at a top of the bit bar 10. In other words, the first surface 100 and the third surface 120 are engageable with the bit 12 in the insertion position and the second surface 108 and the fourth surface 124 is engageable with the bit 12 in the locked position. Additionally, the first ridge 116 and the second ridge 128 are engageable with the bit 12 when the bit 12 is disposed in the first space 104 (FIG. 11) and when the bit 12 is disposed in the second space 105 (FIG. 12).

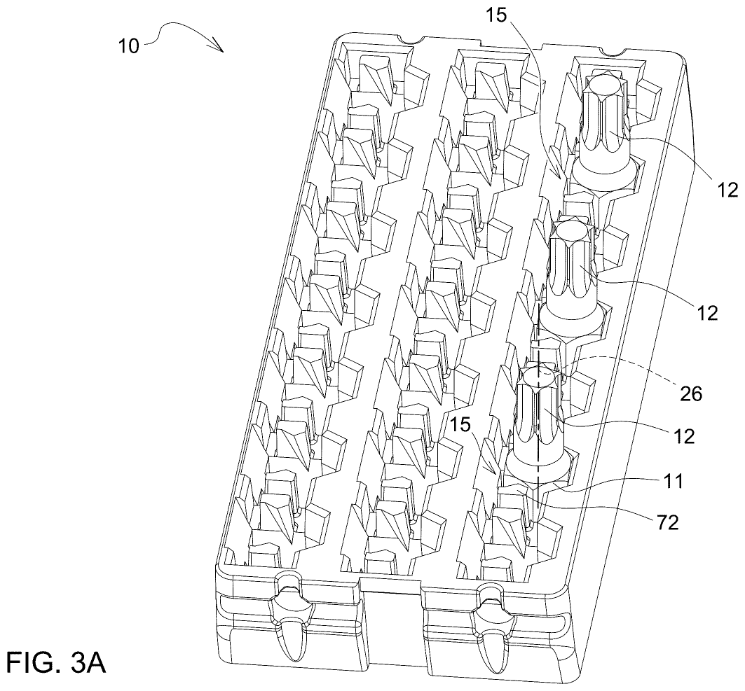

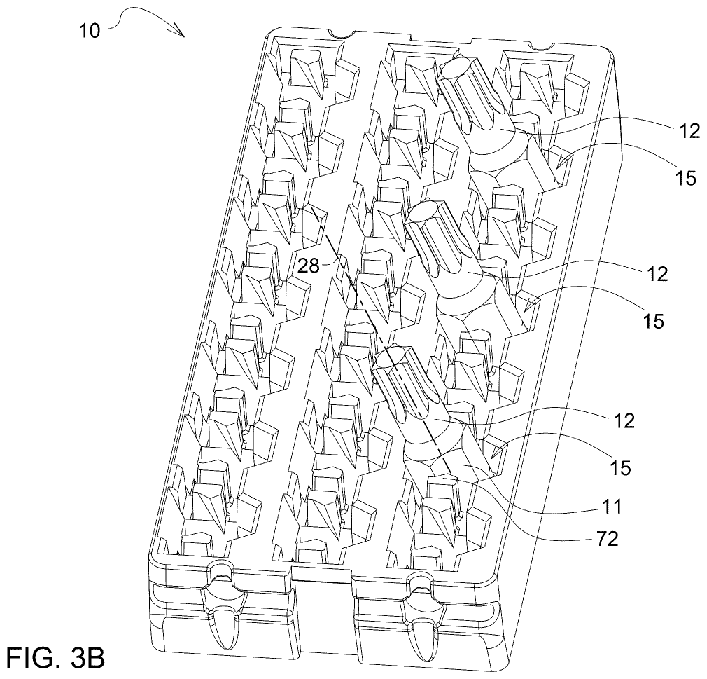

The first space 104 may also be understood as an insertion space and second space 105 may be understood as a locked space. Accordingly, the first space 104 (FIG. 10) is shaped to receive the bits 12 in an unlocked position (FIG. 3A), and the second space 105 (FIG. 11) facilitates locking the bit 12 in place in the locked position (FIG. 3B). The received bit axis 26 is coaxially aligned with a center of the first space 104 and the bit lock axis 28 coaxially aligned with a center of the second space 105. The received bit axis 26 defines the path along which the bit 12 is received by the first space 104. The first space 104 may be tapered slightly from a top of the first space 104 defined by the first side 13 of the bit bar 10 to a bottom defined by the second side 17 of the bit bar 10. Tapering the first space 104 may be advantageous such that the bit 12 is better held in the bit bar 10 does not fall through the bit bar 10.

In some embodiments, such as in the illustrated embodiment, the bit bar 10 has a bit storage density of 4.10 to 5.10 bits per square inch. In some embodiments, such as the illustrated embodiment, the bit bar 10 has a bit storage density of 4.33 to 4.91 bits per square inch. In some embodiments, such as the illustrated embodiment, the bit bar 10 has a bit storage density of 4.56 to 4.68 bits per square inch. In addition to the locking and unlocking functionality provided by the bit bar 10, the design of the bit bar 10 shown and described herein also provides efficient packing of bits 12. Bit bars according to the prior art having a similar bit storage density are not capable of doing so with a locking and unlocking functionality as described herein. A further advantage of the bit bar 10 relative to conventional bit bars of the prior art is the increased ease of removal of the bits 12 in the vertical, non-tilted position.

When the bit 12 is in the unlocked, or insertion position, as shown in FIG. 3A, the bit 12 is disposed in the first space 104 of the receptacle 15 and supported by the first surface 100 of the first projection 72 and the third surface 120 of the second projection 76. In the unlocked position, the bit 12 is easily removable from the bit bar 10. The first surface 100 and the third surface 120 are engageable with or by a first side of the bit 12, and the first receptacle wall 48 is engageable with or by a second side of the bit 12 to support or hold the bit 12 in the insertion position. In the insertion position, while the bit 12 is supported by the first surface 100, the third surface 120, and the first receptacle wall 48, the bit 12 does not resist removal. Rather, the insertion position permits removal of the bit 12. In other words, when the bit 12 is disposed in the first space 104, the bit 12 may be inserted and removed with ease.

When the bit 12 is in the locked position, as shown in FIG. 3B, the bit 12 is disposed in the second space 105 of the receptacle 15 and supported by the second surface 108 of the first projection 72 and the fourth surface 124 of the second projection 76. The second surface 108 and the fourth surface 124 are engageable with or by the second side of the bit 12, the upper planar surface 92 of the second receptacle wall 52 is engageable with or by the second side of the bit 12, and the engagement portion 80 of the first receptacle wall 48 is engageable with or by the first side of the bit 12 to support or hold the bit 12 in the locked position. In the locked position, the engagement portion 80 of the first receptacle wall 48, the upper planar surface 92 of the second receptacle wall 52, and the fourth surface 124 combine to form a friction fit cooperatively holding the bit 12 in place.

To insert and lock the bit 12, a user inserts the bit 12 such that the bit 12 engages the first upper edge 97 and the second upper edge 126 and enters the receptacle 15 along the bit receiver axis 16 into the first space 104 such that the bit 12 is in the insertion position. The bit 12 may then be moved to the locked position by rotating or pivoting the bit 12 from the first space 104 to the second space 105. After the bit 12 has been rotated or pivoted to the locked position, the bit 12 is locked to the bit bar 10 and resists removal. To remove the bit 12, a user pivots the bit 12 from the second space 105 to the first space 104 and thereafter removes the bit 12 along the bit receiver axis 16.

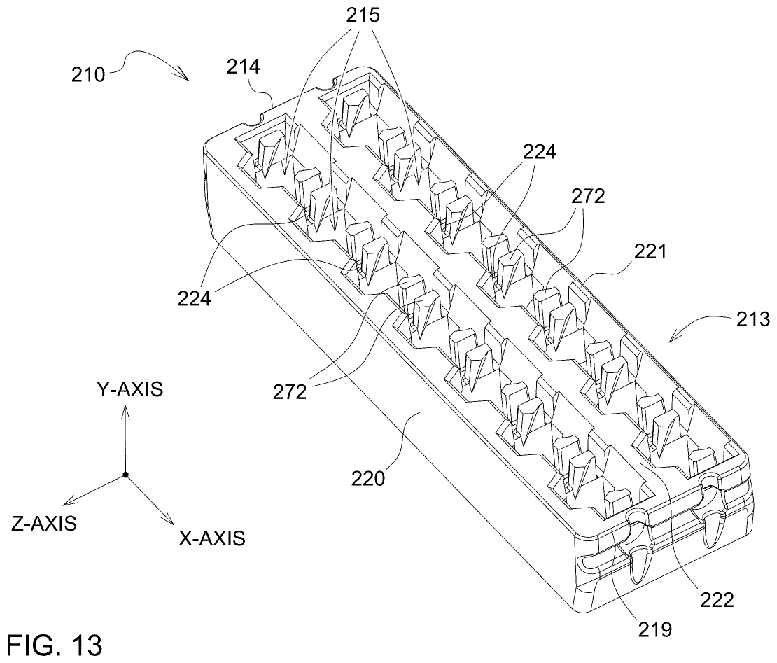

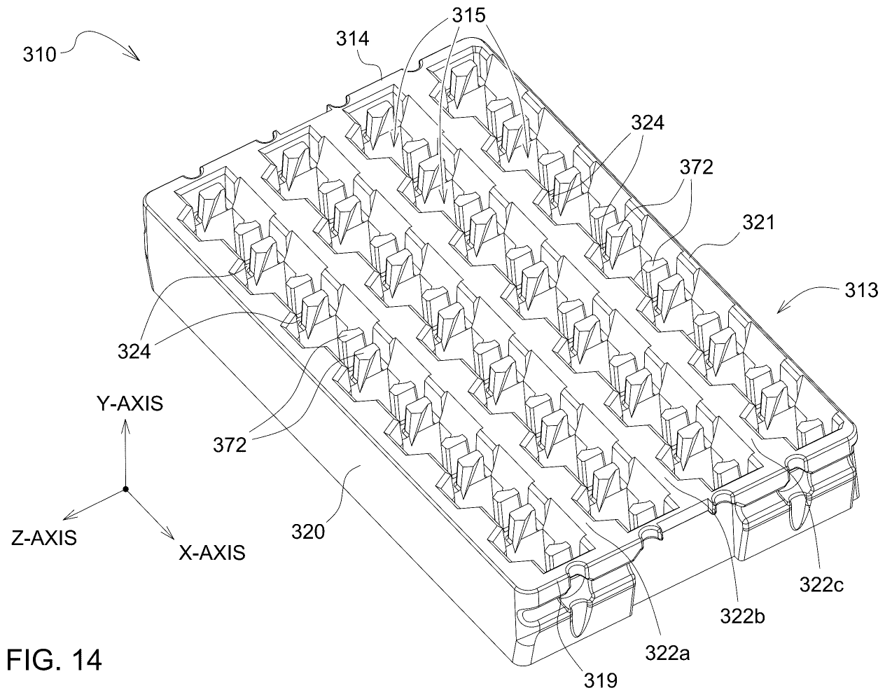

While the bit bar 10 shown in FIGS. 1-12 includes three rows of receptacles 15 (each row having seven receptacles in the illustrated embodiment), other bit holders can have more or fewer rows of bit holders. For example, FIG. 13 illustrates a bit holder 210 having two rows of receptacles 215. Like elements are numbered similarly to those in FIGS. 1-12, though incremented by 200. In a further example, FIG. 14 illustrates a bit holder 310 having four rows of receptacles 315. Like elements are numbered similarly to those in FIGS. 1-12, though incremented by 300. Each of the bit holders 210, 310 (similar to the bit bar 10) include seven receptacles 215, 315 within each row, though in other embodiments, each row may include more or less receptacles 215, 315. In some embodiments, each of the rows includes an equal number of receptacles 15, 215, 315, while in other embodiments, the rows may include dissimilar amounts of receptacles 15, 215, 315. In the illustrated embodiments, the receptacles 15, 215, 315 are formed as a rectangular array, though in other embodiments, the receptacles 15, 215, 315 of one row may be offset from the next.

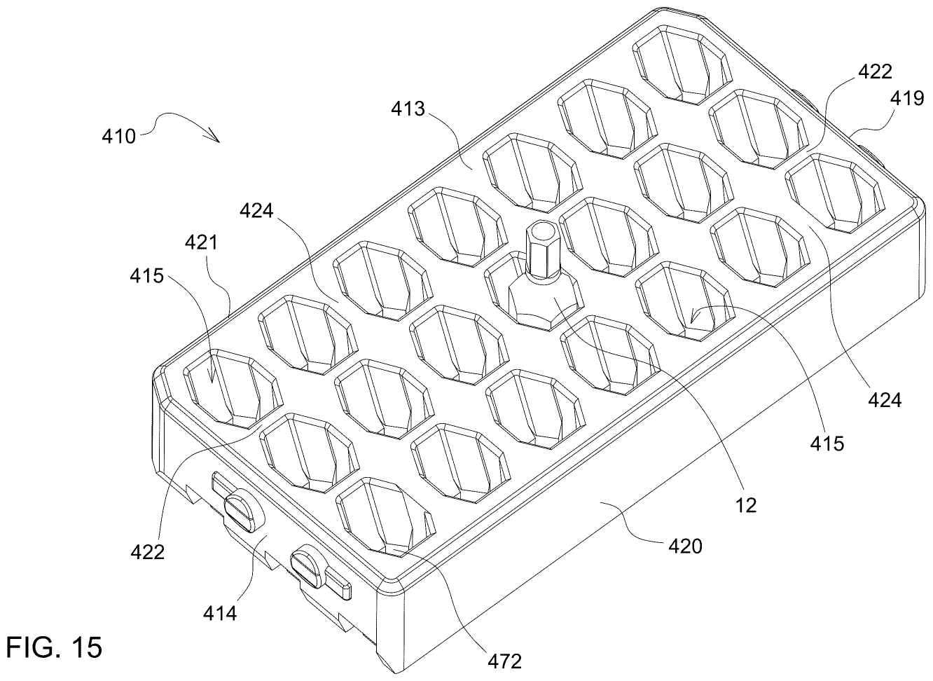

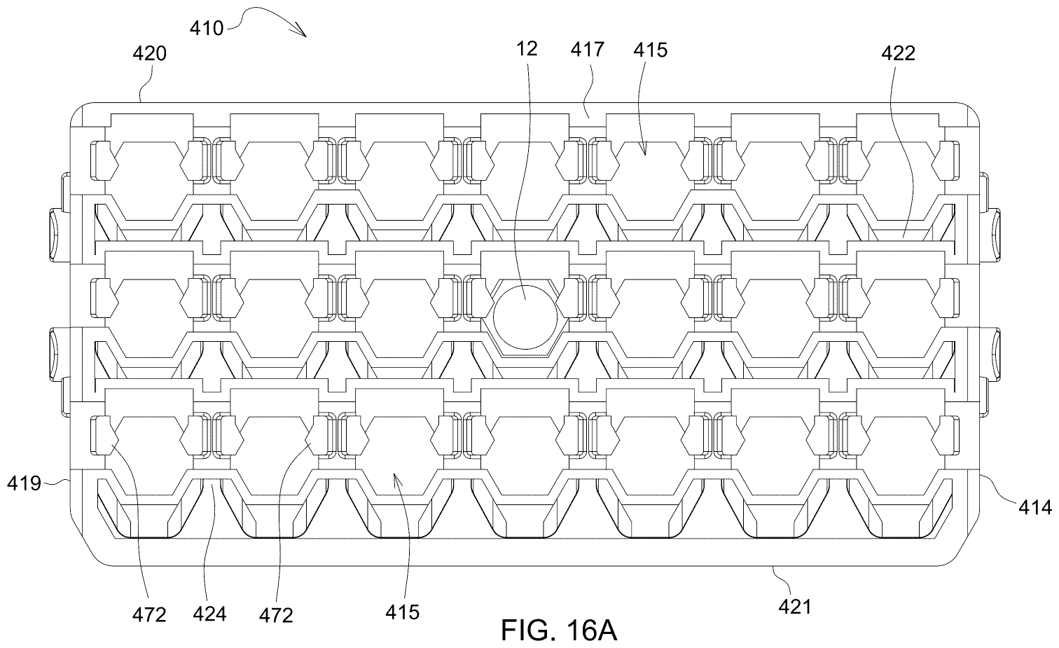

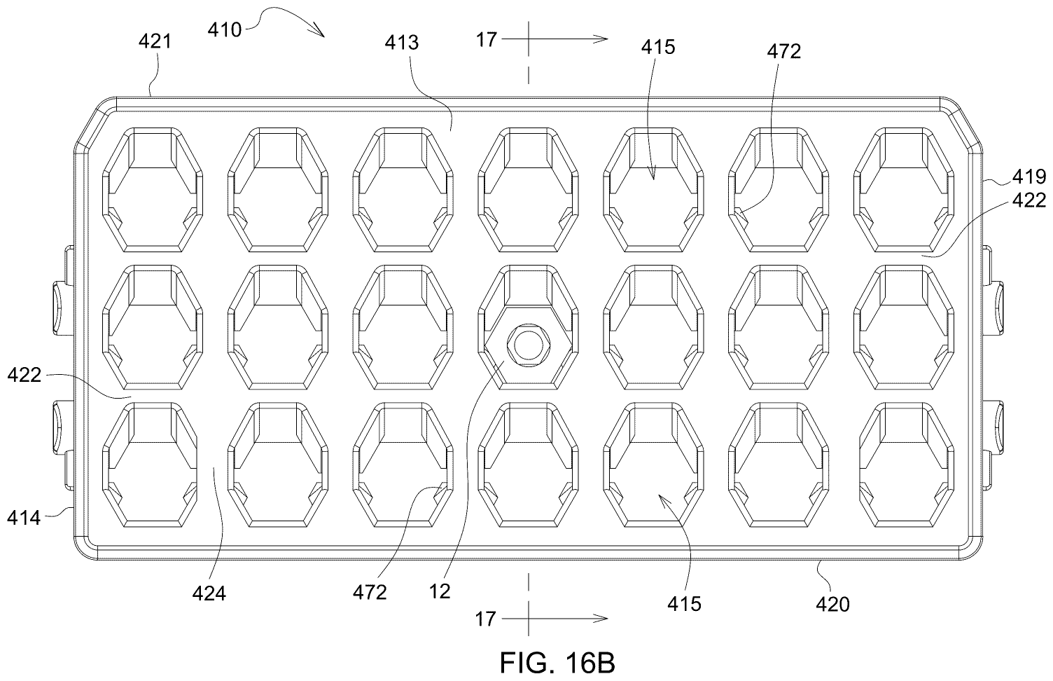

FIGS. 15-17 illustrate an exemplary bit holder formed as a bit bar 410. The bit bar 410 is similar to the bit bar 10 illustrated in FIGS. 1-12 except as otherwise described herein, with like elements identified with like reference numerals incremented by 400. The bit bar 410 includes receptacles 415 that can be used to hold, store, and/or organize a plurality of bits 12 that have a shaped base 11 (e.g., a hex-shaped base for use with hex tools). The bit bar 410 includes a first or upper side 413 that is structured to receive one or more bits 12 (i.e. the first side 413 is a bit receiver side) and a second or lower side 417 (e.g., a base side) that is opposite the first side 413. In contrast to the bit bar 10, the upper side 413 of the bit bar 410 is only interrupted by the hexagonal receptacles 415. In the illustrated embodiment, the receptacles 415 include hexagonal sidewalls. The bit bar 10 of FIGS. 1-12 includes upwardly extending projections 72 (extending upwards between the receptacles 15 towards the upper side 13), whereas the projections 472 extend downward towards the lower side 417 in the embodiment shown in FIGS. 5-17. In this manner, the projections are not visible when a bit 12 is positioned within the receptacle 415 and do not create a visual impact on the upper side 413, even when the bit 12 is removed from the receptacle 415. In this manner, the upper side 413 provides a cleaner aesthetic. Additionally, dust and debris that may fall onto the upper side 413 is less likely to interact (e.g., clog) and impede movement of the projections 472. As the projections 472 extend downward from below the upper side 413, the projections form a complete yet elongated hexagonal shape extending downward from the upper side 413 until the shape is interrupted by the projections 472.

Similar to the bit bar 10, the bit bar 410 includes a first side wall segment 414, a second side wall segment 419 opposite the first side wall segment 14, a first or front perimeter wall segment 420, and a second or rear perimeter wall segment 421 that is opposite the first perimeter wall segment 420, with the four wall segments 414, 419, 420, 421 defining an outer bounds of the bit bar 410 and form a perimeter that is substantially rectangularly-shaped. One or more divider walls 422 extend between the first and second side wall segments 414, 419. Bridge segments 424 extend between and interconnect the first and second perimeter wall segments 420, 421 to adjacent divider walls 422 and interconnect the divider walls 422 to one another.

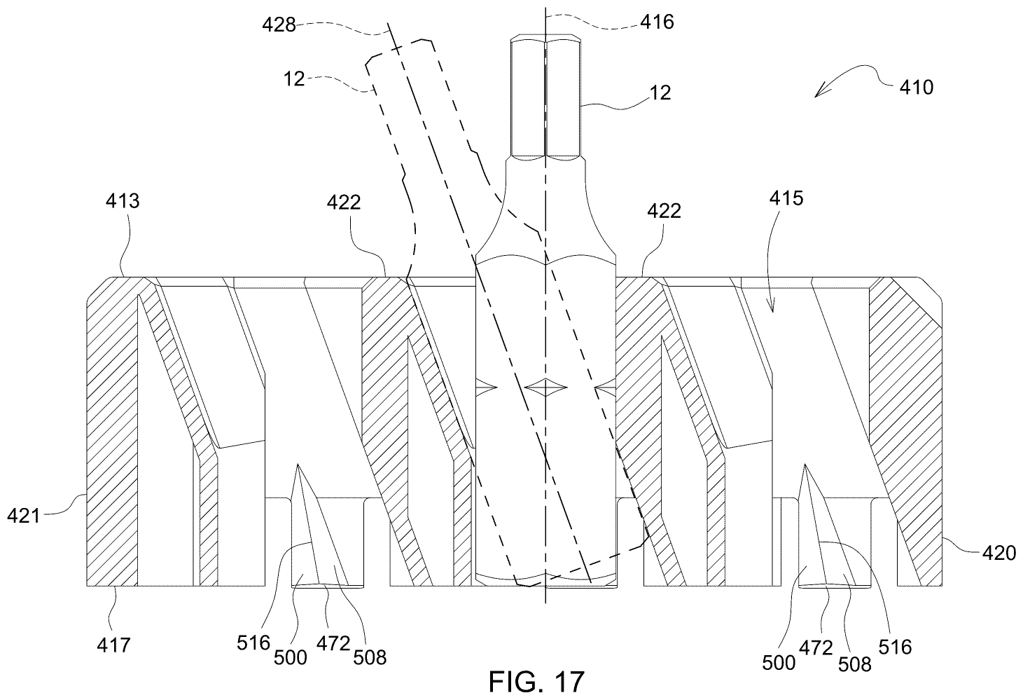

As shown in greater detail in FIG. 17, each receptacle 415 is shaped to receive a corresponding bit 12 and facilitates insertion of the bit 12 into the bit bar 410 and movement of the bit 12 to a locked position that firmly holds the bit 12 in place. Each receptacle 415 has a bit receiver axis 416 along which the bit 12 can be inserted (e.g., received) or removed relative to the bit bar 410, and a bit lock axis 428 corresponding to the locked position of the bit 12 in the receptacle 415.

Although the projections 472 of the bit bar 410 are inverted (extending downward rather than upward) relative to the projections 72 shown in FIGS. 1-12, operation of the bit bar 410 is similar to that described above. Each receptacle 415 includes two projection 472 located on opposite sides of the receptacle 415. Each of the two projections 472 is independently flexible relative to a bridge segment 424 to which the projection 472 is coupled to hold the bit 12 in place (e.g., via a friction fit with walls of the receptacle 415). Each of the two projections 472 includes a first surface 500 that engages with the bit 12 in an insertion position (in which the bit is insertable into and removable from the bit bar 410) and a second surface 508 that engages with the bit 12 in a locked position (in which the bit 12 is not removable from the bit bar 410).

In the illustrated embodiment, the first surface 500 does not engage with the bit 12 in the locked position and the second surface 508 does not engage with the bit 12 in the insertion position. The first and second surfaces 500, 508 are angled relative to one another and, in the illustrated embodiment, the bit 12 does not simultaneously engage both of the first and second surfaces 500, 508. A ridge 516 is an edge defined between the first surface 500 and the second surface 508 and engages with the bit 12 in both the insertion position (when the bit 12 is in an insertion space) and the locked position (when the bit 12 is in a locked space). With continued reference to FIG. 17, which illustrates an exemplary bit 12 in both the locked position (shown via dashed lines) and the insertion position (shown via solid lines), the two illustrations of the bit overlap one another, as the insertion space partially overlaps the locked space.

Although the invention has been described in detail with reference to certain preferred embodiments, variations and modifications exist within the scope and spirit of one or more independent aspects of the invention as described. It will be appreciated that each feature of the bit bar may form the basis of one or more claims on its own or in any combination with any other feature or features. The order in which the features of the bit bar are described in no way informs the features and structures, alone or in combination, that may be novel and inventive. The order that the features have been described is only for convenience and should not be construed as limiting regarding what may be claimed.

Clause 1. A bit holder comprising: a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a first projection extending from the first bridge segment and a second projection extending from the second bridge segment, wherein the first projection is flexible relative to the first bridge segment and the second projection is flexible relative to the second bridge segment such that the first projection and the second projection at least partially cooperatively hold the bit in place.

Clause 2. The bit holder of clause 1, wherein an engagement portion of the first receptacle wall, an upper planar surface of the second receptacle wall, the first projection, and the second projection combine to form a friction fit to cooperatively hold the bit in place.

Clause 3. The bit holder of clause 1, wherein the first receptacle wall is defined by a partial hex-shaped profile, and wherein the second receptacle wall is defined by a planar shaped profile.

Clause 4. The bit holder of clause 1, wherein the second receptacle wall is defined by a lower planar surface and an upper planar surface.

Clause 5. The bit holder of clause 4, wherein the lower planar surface is parallel to a bit receiver axis extending along the first receptacle wall, and wherein the upper planar surface is oriented at a non-zero angle relative to the lower planar surface.

Clause 6. The bit holder of clause 1, wherein the first and second projections are flexible relative to and independent of each other.

Clause 7. The bit holder of clause 1, wherein the first projection extends upward from a top of the first bridge segment and inward relative to the first bridge segment into the receptacle, and, optionally, wherein the second projection extends upward from a top of the second bridge segment and inward relative to the first bridge segment into the receptacle.

Clause 8. The bit holder of clause 1, wherein the bit bar has a bit storage density of 4.10 to 5.10 bits per square inch.

Clause 9. A bit holder comprising: a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a projection extending from the first bridge segment, wherein the projection is flexible relative to the first bridge segment to partially guide the bit into a first pocket defining an insertion position of the bit on insertion into a corresponding receptacle, wherein the projection is further flexible relative to the first bridge segment on movement of the bit from the first pocket to a second pocket defining a locked position of the bit, and wherein projection is engageable with the bit in the insertion position and in the locked position of the bit.

Clause 10. The bit holder of clause 9, wherein the projection is first projection, and wherein the bit bar further includes a second projection.

Clause 11. The bit holder of clause 9, wherein the projection includes a first surface engageable with the bit in the insertion position, and a second surface engageable with the bit in the locked position.

Clause 12. The bit holder of clause 11, wherein the first surface and the second surface are angled relative to one another.

Clause 13. A bit holder comprising: a bit bar defining receptacles each configured to support a bit, each of the receptacles defined by a first receptacle wall and a second receptacle wall opposite the first receptacle wall, the bit bar further including a first projection extending inward into the receptacle, and a second projection extending inward into the receptacle opposite the first projection, wherein each of the first projection and the second projection is flexible relative to each other, and wherein each of the first projection and the second projection includes a first surface cooperating with the first receptacle wall to define a first space, a second surface oriented at a non-zero angle relative to the first surface and cooperating with the second receptacle wall to define a second space at least partially offset from the first space, and a ridge defining an edge disposed between the first surface and the second surface.

Clause 14. The bit holder of clause 13, wherein the ridge is engageable with the bit when the bit is disposed in the first space and when the bit is disposed in the second space.

Clause 15. The bit holder of clause 13, wherein the first space equates to an insertion space and second space equates to locked space.

Clause 16. The bit holder of clause 15, wherein the second space partially overlaps the first space at a top of the bit bar.

Clause 17. The bit holder of clause 13, wherein when the bit is disposed in the first space of the receptacle the bit is supported by the first surface of the first projection.

Clause 18. The bit holder of clause 13, wherein an engagement portion of the first receptacle wall, an upper planar surface of the second receptacle wall, the first projection, and the second projection combine to form a friction fit to cooperatively hold the bit in place.

Clause 19. The bit holder of clause 13, wherein the first surface and the second surface are angled relative to one another at a top of the first projection.

Clause 20. The bit holder of clause 13, wherein the first projection extends from a first bridge segment and the second projection extends from a second bridge segment.

Various features of the disclosure are set forth in the following claims.

1. A bit holder comprising:
a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a first projection extending from the first bridge segment and a second projection extending from the second bridge segment,
wherein the first projection is flexible relative to the first bridge segment and the second projection is flexible relative to the second bridge segment such that the first projection and the second projection at least partially cooperatively hold the bit in place.

2. The bit holder of claim 1, wherein an engagement portion of the first receptacle wall, an upper planar surface of the second receptacle wall, the first projection, and the second projection combine to form a friction fit to cooperatively hold the bit in place.

3. The bit holder of claim 1, wherein the first receptacle wall is defined by a partial hex-shaped profile, and wherein the second receptacle wall is defined by a planar shaped profile.

4. The bit holder of claim 1, wherein the second receptacle wall is defined by a lower planar surface and an upper planar surface.

5. The bit holder of claim 4, wherein the lower planar surface is parallel to a bit receiver axis extending along the first receptacle wall, and wherein the upper planar surface is oriented at a non-zero angle relative to the lower planar surface.

6. The bit holder of claim 1, wherein the first and second projections are flexible relative to and independent of each other.

7. The bit holder of claim 1, wherein the first projection extends upward from a top of the first bridge segment and inward relative to the first bridge segment into the receptacle, and wherein the second projection extends upward from a top of the second bridge segment and inward relative to the first bridge segment into the receptacle.

8. The bit holder of claim 1, wherein the bit bar has a bit storage density of 4.10 to 5.10 bits per square inch.

9. A bit holder comprising:
a bit bar defining receptacles each configured to support a bit, each of the receptacles defined by a first receptacle wall, a second receptacle wall opposite the first receptacle wall, a first bridge segment extending between and interconnecting the first receptacle wall and the second receptacle wall on a first side of the receptacle, and a second bridge segment extending between and interconnecting the first receptacle wall and the second receptacle wall on a second side of the receptacle opposite the first side, the bit bar further including a projection extending from the first bridge segment,
wherein the projection is flexible relative to the first bridge segment to partially guide the bit into a first pocket defining an insertion position of the bit on insertion into a corresponding receptacle,
wherein the projection is further flexible relative to the first bridge segment on movement of the bit from the first pocket to a second pocket defining a locked position of the bit, and
wherein projection is engageable with the bit in the insertion position and in the locked position of the bit.

10. The bit holder of claim 9, wherein the projection is a first projection, and wherein the bit bar further includes a second projection.

11. The bit holder of claim 9, wherein the projection includes a first surface engageable with the bit in the insertion position, and a second surface engageable with the bit in the locked position.

12. The bit holder of claim 11, wherein the first surface and the second surface are angled relative to one another.

13. A bit holder comprising:
a bit bar defining receptacles each configured to support a bit, each of the receptacles defined by a first receptacle wall and a second receptacle wall opposite the first receptacle wall, the bit bar further including a first projection extending inward into the receptacle, and a second projection extending inward into the receptacle opposite the first projection,
wherein each of the first projection and the second projection is flexible relative to each other, and
wherein each of the first projection and the second projection includes a first surface cooperating with the first receptacle wall to define a first space, a second surface oriented at a non-zero angle relative to the first surface and cooperating with the second receptacle wall to define a second space at least partially offset from the first space, and a ridge defining an edge disposed between the first surface and the second surface.

14. The bit holder of claim 13, wherein the ridge is engageable with the bit when the bit is disposed in the first space and when the bit is disposed in the second space.

15. The bit holder of claim 13, wherein the first space equates to an insertion space and second space equates to locked space.

16. The bit holder of claim 15, wherein the second space partially overlaps the first space at a top of the bit bar.

17. The bit holder of claim 13, wherein when the bit is disposed in the first space of the receptacle the bit is supported by the first surface of the first projection.

18. The bit holder of claim 13, wherein an engagement portion of the first receptacle wall, an upper planar surface of the second receptacle wall, the first projection, and the second projection combine to form a friction fit to cooperatively hold the bit in place.

19. The bit holder of claim 13, wherein the first surface and the second surface are angled relative to one another at a top of the first projection.

20. The bit holder of claim 13, wherein the first projection extends from a first bridge segment and the second projection extends from a second bridge segment.
